(19) United States
(12) Patent Application Publication
(10) Pub. No.: US 2017/0317538 A1
(43) Pub. Date: Nov. 2, 2017

(54) ROTOR FOR A ROTARY ELECTRICAL MACHINE

(71) Applicant: VALEO EQUIPEMENTS ELECTRIQUES MOTEUR, Creteil Cedex (FR)

(72) Inventors: Stéphane CALON, Etaples Sur Mer (FR); Mostafa KADIRI, Le Touquet (FR); Amar DJEBBAR, Etaples (FR); Stephane DESENCLOS, Tubersent (FR); Benjamin POUCHELLE, Etaples (FR); Guillaume DUFOUR, Berk Sur Mer (FR)

(21) Appl. No.: 15/523,531

(22) PCT Filed: Nov. 9, 2015
(86) PCT No.: PCT/EP2015/076079

§ 371 Date: May 1, 2017

(30) Foreign Application Priority Data
Nov. 12, 2014 (FR) 1458118
Aug. 6, 2015 (FR) PCT/FR2015/052173

(51) Int. Cl. H02K 1/22; H02K 1/24

(52) U.S. Cl. CPC H02K 1/226; H02K 1/243

(57) ABSTRACT

The invention relates to a rotor for a rotating electrical machine, comprising: a central shaft, an annular core coaxial to the shaft, a winding extending radially around the core, a first claw-pole and a second claw-pole arranged axially on each side of the core and the winding. Each claw-pole of the rotor comprises a plurality of triangular teeth having a base that is tangent to the pole wheel and comprising a first side, denoted a, and a second side, denoted b. The ratio of 1-a/b is between 0 and 0.5, or 0 and −0.5. The tip of the teeth of one of the claw-poles is equidistant between the ends of the bases adjacent to the tip of the teeth of the other claw-pole.

### FIELD OF THE INVENTION

The present invention relates to a rotor for a rotary electrical machine, such as an alternator or an alternator-starter, in particular for a motor vehicle.

The invention applies in particular to a rotor of a rotary electrical machine, such as an alternator or an alternator-starter, in particular for a motor vehicle, which comprises:
a central shaft;
an annular core which is coaxial to the shaft;
a winding which extends radially around the core; and
two claw-poles which are arranged axially on both sides of the core and the winding.

### BACKGROUND OF THE INVENTION

Document US 2007/0024153 describes a rotor which has two claw-poles. Each claw-pole is constituted by a plurality of teeth. The top of each tooth is offset, and the sides of each tooth are slightly curved. The offsetting of the top of the tooth and the curvature of the sides of the tooth reduces the magnetic noise generated by the rotor. However, this configuration does not reduce sufficiently the sum of the magnetic noises, whilst avoiding magnetic short-circuits between the two claw-poles.

The objective of the present invention is to eliminate these disadvantages, and to propose a rotor for an alternator which makes it possible to reduce the sum of the magnetic noises, whilst limiting the magnetic short-circuits.

### SUMMARY OF THE INVENTION

The aim of the present invention is to eliminate these disadvantages.

For this purpose, according to a first aspect, the present invention relates to a rotor of a rotary electrical machine which comprises:
a central shaft;
an annular core which is coaxial to the shaft;
a winding which extends radially around the core;
a first claw-pole and a second claw-pole which are arranged axially on both sides of the core and the winding;
   each claw-pole comprises a plurality of teeth with a triangular form, wherein:
the base is tangent to the claw-pole and comprises a first side, indicated as a, and a second side, indicated as b;
the ratio of 1-a/b is between 0 and 0.5 or 0 and −0.5;
the top of the teeth of one of the claw-poles is equidistant between the ends of the bases adjacent to the top of the teeth of the other claw-pole.

By means of these arrangements, the magnetic noise is reduced, whilst maintaining a sufficient distance between the tops of the teeth of one claw-pole relative to the teeth in the vicinity of the other claw-pole, in order to avoid magnetic short-circuits.

The distance between two adjacent bases of a claw-pole a top of a tooth of the other claw-pole is measured when the two claw-poles are assembled.

According to one embodiment, the shaft comprises a drive section, the cross-section of which according to a radial plane is not smooth, and which is forced axially into a bore for securing of a component of the rotor, such as to render the shaft integral in rotation with the first claw-pole and the second claw-pole.

According to one embodiment, the ratio is between 0.1 and 0.3 or −0.1and −0.3. According to another embodiment, the ratio is either between 0.1 and 0.5 or −0.1 and −0.5, or between 0.3 and 0.5 or −0.3 and −0.5, or between 0.4 and 0.5 or −0.4 and −0.5.

According to one embodiment, the ratio of the first claw-pole is between 0 and −0.5, for example between −0.1 and −0.3, and the ratio of the second claw-pole is between 0 and −0.5, for example between −0.1 and −0.3.

When the ratio is other than 0, there is offsetting between the straight line which is perpendicular to the base of the triangle and passes via its middle and the bisector of the angle formed by the first side and the second side. Relative to the direction of rotation, the offsetting is either in advance or delayed.

According to one embodiment, the ratio of the first claw-pole is between 0 and 0.5, for example between 0.1 and 0.3, and the ratio of the second claw-pole is between 0 and 0.5, for example between 0.1 and 0.3. In this embodiment, the first claw-pole is delayed relative to the direction of rotation, and the second claw-pole is delayed relative to the direction of rotation.

According to one embodiment, the ratio of the first claw-pole is between 0 and −0.5, for example between −0.1 and −0.3, and the ratio of the second claw-pole is between 0 and 0.5, for example between 0.1 and 0.3. In this embodiment, the first claw-pole is in advance relative to the direction of rotation, and the second claw-pole is delayed relative to the direction of rotation.

According to one embodiment, the ratio of the first claw-pole is between 0 and 0.5, for example between 0.1 and 0.3, and the ratio of the second claw-pole is between 0 and −0.5, for example between −0.1 and −0.3. In this embodiment, the first claw-pole is delayed relative to the direction of rotation, and the second claw-pole is also in advance relative to the direction of rotation.

According to one embodiment, the distance between an end of the base of a tooth of the first claw-pole and the proximal end of the base of a tooth of the second claw-pole is greater than the half width of the base of a tooth of the first claw-pole or the base of a tooth of the second claw-pole.

Thus, this distance avoids short-circuits occurring between the first claw-pole and the second claw-pole.

According to one embodiment, the top of the teeth of each of the claw-poles is equidistant between the ends of the bases adjacent to the top of the teeth of the other claw-pole, when the two claw-poles are assembled.

Thus, the first claw-pole and the second claw-pole have the same configuration.

According to one embodiment, the first side or the second side comprises a rounded edge.

Thus, the rounded edge prevents impacts between two teeth of the two claw-poles, and reduces the sum of the magnetic noises.

According to one embodiment, the rotor additionally comprises magnets, the magnets being arranged between two adjacent teeth which belong to the first and second claw-poles respectively.

Independently from, or in combination with, the foregoing, the invention also relates to a rotor of a rotary electrical machine comprising:
a central shaft;
an annular core which is coaxial to the shaft;
a winding which extends radially around the core;
a first claw-pole and a second claw-pole which are arranged axially on both sides of the core and the winding, each claw-pole comprising a plurality of teeth with a triangular form, wherein the base is tangent to the claw-pole, and comprising a first side and a second side, such that each first side of the first claw-pole is opposite a second side of the second claw-pole at the inter-tooth space;

the teeth of one of the first or the second claw-poles being such that the length of the first side, indicated as a, is strictly longer than the length of the second side, indicated as b;

the teeth of the other one of the first or second claw-poles being such that the length of the first side, indicated as a′, is strictly shorter than the length of the second side, indicated as b′.

According to one embodiment, the plurality of the teeth of the first claw-pole has a ratio, indicated as R1, equal to 1-(a/b), and the plurality of the teeth of the second claw-pole has a ratio, indicated as R2, equal to 1-(a′/b′), R1 being equal to R2 as an absolute value.

This configuration makes it possible to have a constant width between the teeth.

According to one embodiment, the ratios R1 and R2 are such that they are other than zero, each ratio being equal to 0.8 or less, and in particular equal to 0.5 or less.

According to one embodiment, the rotor additionally comprises magnets, the magnets being arranged between two adjacent teeth which belong to the first and second claw-poles respectively.

According to one embodiment, the magnets, which in particular have a substantially parallelepiped form, have parallel edges.

Independently from, or in combination with, the foregoing, the invention also relates to a rotor of a rotary electrical machine comprising:
a central shaft;
an annular core which is coaxial to the shaft;
a winding which extends radially around the core;
a first claw-pole and a second claw-pole which are arranged axially on both sides of the core and the winding;

each claw-pole comprises a plurality of teeth with a triangular form, wherein the base is tangent to the claw-pole and comprises a first side, indicated as a, and a second side, indicated as b;

the plurality of teeth of the first claw-pole being such that a difference of length exists between the first side and the second side;

the first and second claw-poles being delayed relative to the direction of rotation of the rotor.

According to one embodiment, the plurality of teeth of the first claw-pole has a ratio, indicated as R1, equal to 1-(a/b), and the plurality of teeth of the second claw-pole has a ratio, indicated as R2, equal to 1-(a′/b′), R1 being equal to R2.

According to one embodiment, the ratios R1 and R2l are such that they are other than zero, each ratio being equal to 0.8 or less, and in particular equal to 0.5 or less.

According to one embodiment, the rotor additionally comprises magnets, the magnets being arranged between two adjacent teeth which belong to the first and second claw-poles respectively.

Independently from, or in combination with, the foregoing, the invention also relates to a rotor of a rotary electrical machine comprising:
a central shaft;
an annular core which is coaxial to the shaft;
a winding which extends radially around the core;
a first claw-pole and a second claw-pole which are arranged axially on both sides of the core and the winding;

each claw-pole comprises a plurality of teeth with a triangular form, wherein the base is tangent to the claw-pole and comprises a first side, indicated as a, and a second side, indicated as b; the plurality of teeth of the first claw-pole being such that a difference of length exists between the first side and the second side;

the first and second claw-poles being in advance relative to the direction of rotation of the rotor.

According to one embodiment, the plurality of teeth of the first claw-pole has a ratio, indicated as R1, equal to 1-(a/b), and the plurality of teeth of the second claw-pole has a ratio, indicated as R2, equal to 1-(a′/b′), R1 being different from R2.

As a variant, R1 is equal to R2.

According to one embodiment, the ratios R1 and R2 are such that they are between −0.8 and −0.26, and in particular between −0.5 and −0.26.

According to one embodiment, the rotor additionally comprises magnets, the magnets being arranged between two adjacent teeth which belong to the first and second claw-poles respectively.

Finally, the invention relates to a rotary electrical machine comprising a rotor as previously described.

### BRIEF DESCRIPTION OF THE DRAWINGS

Other advantages, objectives and characteristics of the present invention will become apparent from the following description which is provided for the purpose of explanation and is in no way limiting, with reference to the appended drawings in which:

FIG. 1 represents a schematic view of the teeth of a first claw-pole and a second claw-pole according to a first particular embodiment of the rotor which is the subject of the present invention, the rotor being observed laterally;

FIG. 2 represents a schematic view of the teeth of a first claw-pole and a second claw-pole according to a second particular embodiment of the rotor which is the subject of the present invention, the rotor being observed laterally;

FIG. 3 represents a schematic view of the teeth of a first claw-pole and a second claw-pole according to a third particular embodiment of the rotor which is the subject of the present invention, the rotor being observed laterally;

FIG. 4 represents a schematic view of the teeth of a first claw-pole and a second claw-pole according to a fourth particular embodiment of the rotor which is the subject of the present invention, the rotor being observed laterally;

FIG. 5 represents a graph of the measurement of the noise of two rotors;

FIG. 6 represents a schematic view of a symmetrical tooth and an asymmetrical tooth;

FIG. 7 represents a schematic view of the implantation of a tooth of one claw-pole relative to two teeth of the other claw-pole;

FIG. 8 represents the implantation of two teeth of two claw-poles and the minimum offsetting to have when the two claw-poles are assembled;

FIG. 9 represents a schematic view of the teeth of a first claw-pole and a second claw-pole according to a fifth particular embodiment of the rotor which is the subject of the present invention, the rotor being observed laterally;

FIG. 10 represents a schematic view of the teeth of a first claw-pole and a second claw-pole according to a sixth particular embodiment of the rotor which is the subject of the present invention, the rotor being observed laterally.

### DETAILED DESCRIPTION OF THE PREFERRED EMBODIMENT(S)

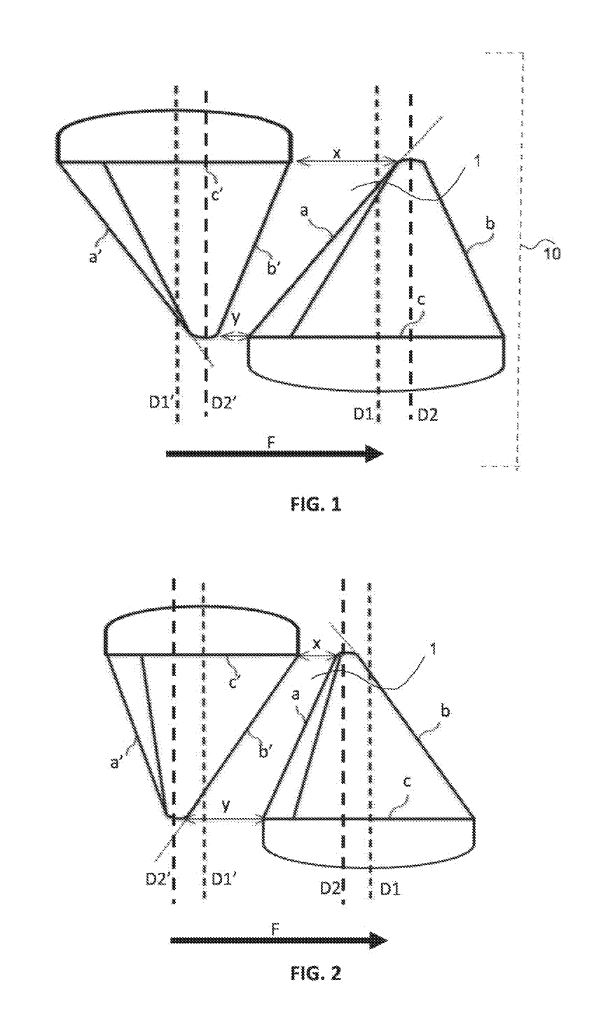

FIG. 1 shows a first embodiment, and more particularly it shows a tooth, also known as a claw, of a first claw-pole and a tooth of a second claw-pole. A tooth has a triangular form with a base, a first side and a second side. The top of the triangle is formed by the first side and the second side.

The rotor has two claw-poles which are assembled such that the teeth fit together face-to-face and next to one another. The distance between the top of a tooth of the first claw-pole relative to the adjacent base of the second claw-pole is indicated as x. The distance between the base of a tooth of the first claw-pole and the top of an adjacent tooth of the second claw-pole is indicated as y. In this figure, the top of the tooth corresponds to one of the ends of the first side a of the triangle of the tooth.

The base of the tooth, indicated as c and c′, is tangent to the claw-pole (not represented). A straight line D1 is perpendicular to the base c, and passes via the middle of the said base c. In the same way, a straight line D1′ is perpendicular to the base c′ and passes via the middle of the said base c′.

The triangular form of the tooth shows that there is offsetting between the straight line D2 which passes via the top of the tooth and the straight line D1. In the same way, the figure shows offsetting on the other tooth between the straight line D2′ which passes via the top of the tooth and the straight line D1′. The straight lines D2 and D2′ are respectively parallel to the straight lines D1 and D1′.

The offsetting is derived from the difference of length between the first side a of a tooth and the second side b of the same tooth. In fact, the first side a, a′ is larger than the second side b, b′. The ratio of 1-a/b (or 1-a′/b′) is variable according to the form of the tooth required. It can vary from 0 to −0.5 or from 0 to 0.5, or any other value included in this range.

For example a=19.58 mm and b=13.85 mm. The ratio gives: 1−19.58/13.85=−0.41.

The first side a, a′ comprises a rounded edge. The second side b, b′ is an edge constituted by a ridge.

The arrow F shows the direction of rotation of the rotor.

The offsetting of the straight line D2 relative to the straight line D1 is in the direction of the arrow F.

FIG. 2 shows a second embodiment. It shows offsetting of the straight line D2 relative to the straight line D1. This offsetting is in the direction which is the inverse of that of the arrow F. This figure has the same characteristics as FIG. 1, with the exception that the first side a, a′ is smaller than the second side b, b′.

FIG. 3 shows a third embodiment. In this figure, the tooth of the first claw-pole is constituted by a first side a which is identical to the second side b. The straight lines D1 and D2 of the tooth of the first claw-pole are combined.

The tooth of the second claw-pole has its first side a′ which is larger than the second side b′. This difference involves offsetting between the straight lines D2′ and D1′. The straight line D2′ is before the straight line D1′ relative to the direction of the arrow F.

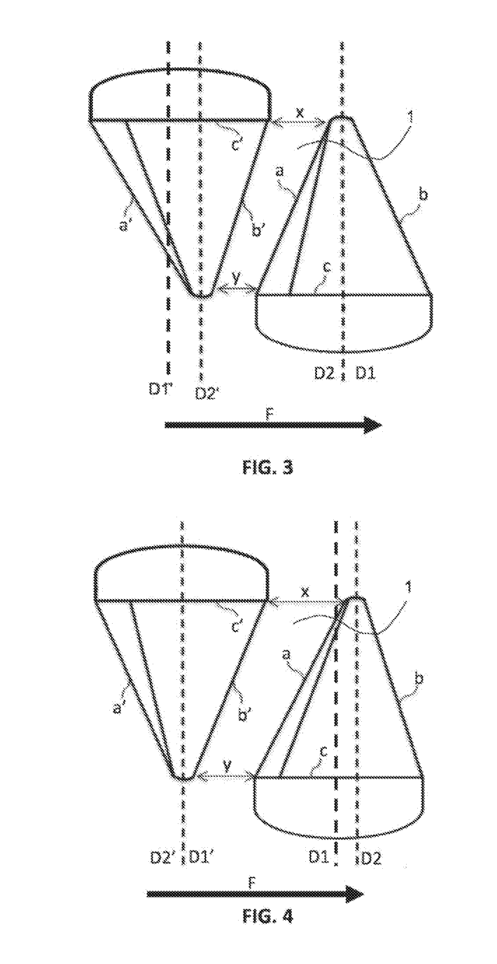

FIG. 4 shows a fourth embodiment. In this figure, the tooth of the second claw-pole is constituted by a first side a which is identical to the second side b. The straight lines D1′ and D2′ of the tooth of the second claw-pole are combined.

The tooth of the first claw-pole has its first side a which is larger than the second side b. This difference involves offsetting between the straight lines D1 and D2. The straight line D2 is after the straight line D1 relative to the direction of the arrow F.

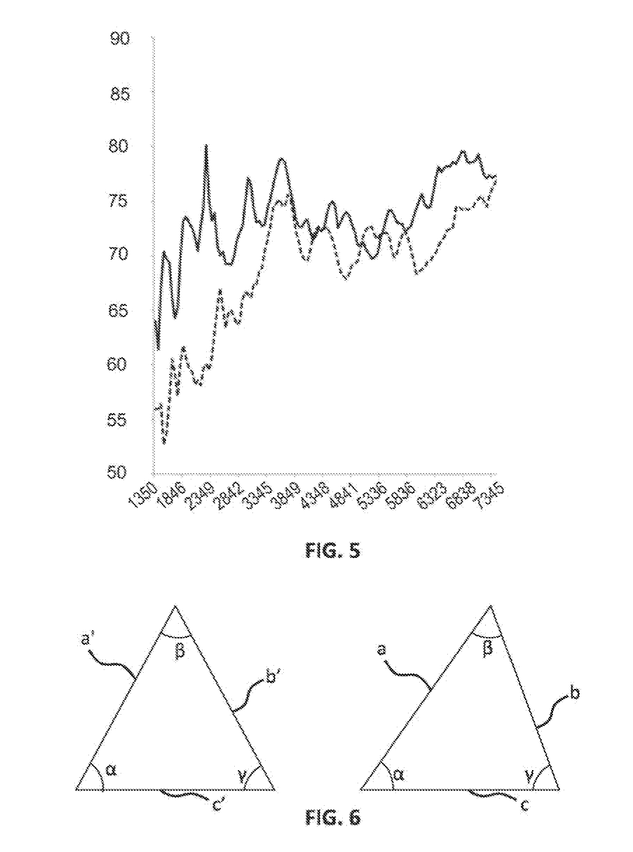

FIG. 5 represents a graph of the measurement of the sum of the magnetic noises. The Y-axis of the graph is in decibels, and the X-axis is in revolutions per minute. The measurement is made in a semi-anechoic chamber.

A semi-anechoic chamber, also known as a dead room, is an experimentation room where all the walls except the ground are covered with dihedrons. These dihedrons absorb the sound waves whilst reproducing free field conditions (no reverberation on the walls), thus not giving rise to an echo which could disrupt the measurements. The dihedrons are generally constituted by a porous material (polymer foam, glass fibre) which absorbs the sound waves.

The said chamber is used to calculate the acoustic power of the alternators.

In order to carry out the measurements, it is necessary to have more elements:
a structure to secure the alternator;
twenty microphones arranged in an arc of a circle at 1 m around the alternator;
an electric motor;
a tachometer;
an automaton;
a battery;
an electronic charge;
a signal generator;
measurement software: LMS (Louvain Measurement System, registered trademark).

The power calculated in the chamber is the result of calculations carried out by the software on the basis of the acoustic pressure (in Pa) measured by means of the twenty microphones arranged all around the alternator. These pressure measurements are made according to the frequency of rotation of the machine for the different positions of the microphones (for example, the position of the microphones is derived from standard NF EN ISO 3745).

The calculations are carried out by means of the following formula (approach defined by the standard):

$$Lw = \overline{Lp} + 10 log ( \frac{S}{S 0} ) + K$$

where:
−Lw=Acoustic power level in dB(A)
L̅p̅=Acoustic pressure level measured in dB(A)
S=The area of the test hemisphere=2πm²
S0=The reference area=1 m²
K=Correction which takes into account the ambient temperature and pressure.

This figure shows the comparison of two measurements between:
an alternator with claw-poles, each tooth of which is constituted by a first side identical to the second side; and
an alternator with claw-poles, one claw-pole of which has teeth with a first side a which is larger than a second side b.

The graph shows that the difference in decibels (dB) between the two alternators is approximately 12 dB. The configuration of the alternator corresponding to the subject of the present invention is optimised, and makes possible reduction of the sums of the magnetic noises of approximately 10%.

FIG. 6 shows how to calculate the ratio. There is representation of two teeth, one symmetrical and one asymmetrical. Going from the symmetrical tooth to the asymmetrical tooth, there is a variation of 2.15°. The angle a in the symmetrical tooth is 60° and in the asymmetrical tooth it is 57.85°. The angle β is identical, i.e. 60°. In the symmetrical tooth the angle y is 60°, and in the asymmetrical tooth it is 62.15°.

Calculation of the ratio:

$$c = {c}^{′} = 27 mm$$

$$tan ( 57.85 ) = \frac{b}{c}$$

$$tan ( 57.85 ) \cdot c = b$$

$$b = tan ( 57.85 ) \cdot 27 = 41.81 mm$$

$$sin ( 57.87 ) = \frac{b}{c} where b = 41.81 mm$$

$$sin ( 57.87 ) = \frac{41.81}{a} \\ a = \frac{41.81}{sin ( 57.85 )} = 49.38 mm$$

Ratio:

$$1 - \frac{a}{b} = 1 - \frac{49.38}{41.81} = 0.15$$

Calculation of the ratio corresponds to the calculation in FIG. 5, in which the alternator has a claw-pole with teeth wherein each first side a is larger than the second side b.

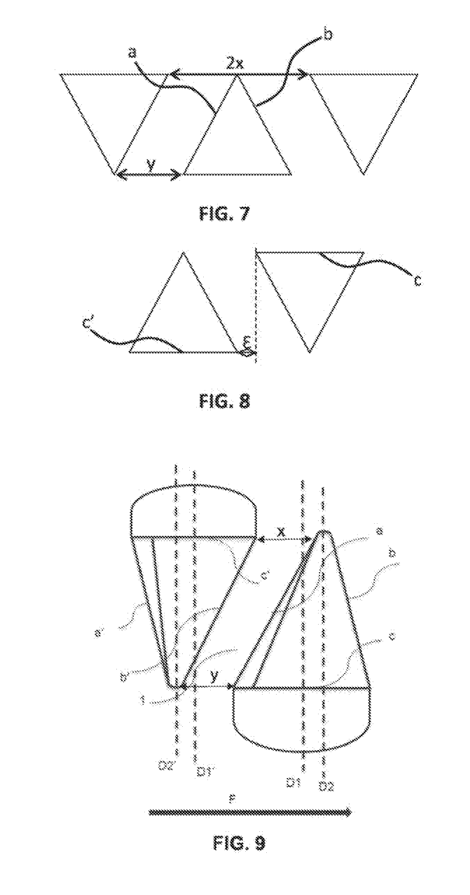

FIG. 7 shows another aspect of the invention which contributes towards avoiding the magnetic short-circuits.

According to one embodiment, the top of a tooth of a claw-pole is equidistant from the proximal bases of two teeth situated on both sides of the top of the said tooth. The length, indicated as 2x, corresponds to the distance between two proximal ends of the base of two adjacent teeth of the same claw-pole.

FIG. 8 shows offsetting of implantation when the two claw-poles are assembled. The distance, indicated as ε, between an end of the base c of a tooth of the first claw-pole and the proximal end of the base c′ of a tooth of the second claw-pole, is greater than the half width of the base c of a tooth of the first claw-pole or of the base c′ of a tooth of the second claw-pole. This characteristic avoids having a magnetic short-circuit between the first claw-pole and the second claw-pole.

FIG. 9 shows a fifth embodiment. In this figure, the tooth of the second claw-pole has its first side a′ smaller than the second side b′. This difference involves offsetting between the straight lines D2′ and D1′. The straight line D2′ is before the straight line D1′ relative to the direction of rotation represented by the arrow F.

The tooth of the first claw-pole has its first side a larger than the second side b. This difference involves offsetting between the straight lines D1 and D2. The straight line D2 is after the straight line D1 relative to the direction of the arrow F.

Thus, in this embodiment, the first claw-pole is delayed relative to the direction of rotation and the second claw-pole is in advance relative to the direction of rotation. In the example represented, the offsetting value of two claw-poles is the same as an absolute value. In other words, the two claw-poles have the same ratio as an absolute value. This has the effect that the distances x and y are equal. It is thus possible to insert magnets with a parallelepiped form between the claws.

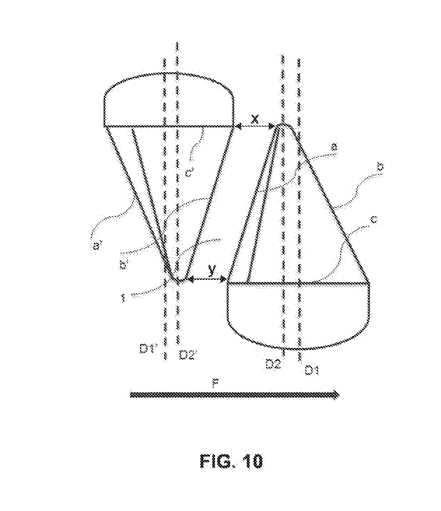

FIG. 10 shows a sixth embodiment identical to the fifth embodiment, the only difference being that the first claw-pole is in advance relative to the direction of rotation and the second claw-pole is delayed relative to the direction of rotation. In fact, the tooth of the second claw-pole has its first side a′ larger than the second side b′, and the tooth of the first claw-pole has its first side a smaller than the second side b.

The embodiments in FIGS. 9 and 10 have in common the fact that one of the claw-poles has its teeth in advance relative to the direction of rotation, and the other one of the claw-poles has its teeth delayed relative to the direction of rotation. In the case when the offsetting of each claw-pole has the same value as an absolute value, there is then a space with a constant width (x, y) between the claw-poles.

### LIST OF PARTS

a, a′ first side of the tooth
b, b′ second side of the tooth
c, c′ base of the tooth
α angle formed between the first side and the base of the tooth
β angle formed between the first side and the second side
γ angle formed between the second side and the base of the tooth
F direction of rotation of the rotor
X distance between the end of the base of a claw pole and the end of the closest first side of the other claw pole
Y distance between the end of a claw pole and the end of the closest base of the other claw pole
D1, D1′ straight line perpendicular to the base which passes through its middle
D2, D2′ bisector of the angle formed by the first side and the second side

1. Rotor (10) of a rotary electrical machine comprising:
a central shaft;
an annular core which is coaxial to the shaft;
a winding which extends radially around the core;
a first claw-pole and a second claw-pole which are arranged axially on both sides of the core and the winding, each claw-pole comprising a plurality of teeth with a triangular form, wherein the base (c, c′) is tangent to the claw-pole, and comprising a first side (a, a′) and a second side (b, b′), such that each first side (a, a′) of the first claw-pole is opposite a second side (b, b′) of the second claw-pole at the inter-tooth space,
the teeth of one of the first or the second claw-poles are such that the length of the first side (a, a′) is strictly longer than the length of the second side (b, b′); and
the teeth of the other one of the first or second claw-poles are such that the length of the first side (a, a′) is strictly shorter than the length of the second side (b, b′).

2. Rotor according to claim 1, wherein the plurality of the teeth of the first claw-pole has a ratio R1 equal to 1-(a/b), and the plurality of the teeth of the second claw-pole has a ratio R2, equal to 1-(a′/b′).

3. Rotor according to claim 2, wherein, as an absolute value, R1 is equal to R2t while being other than zero, the ratio being equal to 0.8 or less, and in particular equal to 0.5 or less.

4. Rotor according to claim 1, wherein the distance between an end of the base of a tooth of the first claw-pole and the proximal end of the base of a tooth of the second claw-pole is greater than the half width of the base of a tooth of the first claw-pole or the base of a tooth of the second claw-pole.

5. Rotor according to claim 1, wherein, the first sides (a, a′) or the second sides (b, b′) of the teeth of the claw-poles comprise a rounded edge.

6. Rotor according to claim 1, wherein the shaft comprises a drive section, the cross-section of which according to a radial plane is not smooth, and which is forced axially into a bore for securing of a component of the rotor, such as to render the shaft integral in rotation with the first claw-pole and the second claw-pole.

7. Rotor according to claim 1, comprising magnets (1), the magnets being arranged between two adjacent teeth which belong to the first and second claw-poles respectively.

8. Rotor according to claim 7, the magnets having parallel edges.

9. Rotary electrical machine for a motor vehicle comprising a rotor according to claim 1.

10. Rotor according to claim 2, wherein the distance between an end of the base of a tooth of the first claw-pole and the proximal end of the base of a tooth of the second claw-pole is greater than the half width of the base of a tooth of the first claw-pole or the base of a tooth of the second claw-pole.

11. Rotor according to claim 3, wherein the distance between an end of the base of a tooth of the first claw-pole and the proximal end of the base of a tooth of the second claw-pole is greater than the half width of the base of a tooth of the first claw-pole or the base of a tooth of the second claw-pole.

12. Rotor according to claim 2, wherein, the first sides (a, a′) or the second sides (b, b′) of the teeth of the first and second claw-poles comprise a rounded edge.

13. Rotor according to claim 3, wherein, the first sides (a, a′) or the second sides (b, b′) of the teeth of the first and second claw-poles comprise a rounded edge.

14. Rotor according to claim 4, wherein, the first sides (a, a′) or the second sides (b, b′) of the teeth of the first and second claw-poles comprise a rounded edge.

15. Rotor according to claim 2, wherein the shaft comprises a drive section, the cross-section of which according to a radial plane is not smooth, and which is forced axially into a bore for securing of a component of the rotor, such as to render the shaft integral in rotation with the first claw-pole and the second claw-pole.

16. Rotor according to claim 3, wherein the shaft comprises a drive section, the cross-section of which according to a radial plane is not smooth, and which is forced axially into a bore for securing of a component of the rotor, such as to render the shaft integral in rotation with the first claw-pole and the second claw-pole.

17. Rotor according to claim 4, wherein the shaft comprises a drive section, the cross-section of which according to a radial plane is not smooth, and which is forced axially into a bore for securing of a component of the rotor, such as to render the shaft integral in rotation with the first claw-pole and the second claw-pole.

18. Rotor according to claim 5, wherein the shaft comprises a drive section, the cross-section of which according to a radial plane is not smooth, and which is forced axially into a bore for securing of a component of the rotor, such as to render the shaft integral in rotation with the first claw-pole and the second claw-pole.
